(19) United States
(12) Patent Application Publication
(10) Pub. No.: US 2011/0063457 A1
(43) Pub. Date: Mar. 17, 2011

(54) Arrangement for controlling networked PTZ cameras

(75) Inventor: Masayuki Tokumitsu, Kyoto (JP)

(73) Assignee: OKI ELECTRIC INDUSTRY CO., LTD., Tokyo (JP)

(21) Appl. No.: 12/805,130

(22) Filed: Jul. 14, 2010

(30) Foreign Application Priority Data
Sep. 11, 2009 (JP) 2009-210220

(51) Int. Cl. H04N 5/232

(52) U.S. Cl. 348/207.11; 348/E05.024

(57) ABSTRACT

A camera controller allows the user to control a predominant camera currently shooting a subject and its nearby cameras simply by manipulating the predominant camera. The camera controller is communicably connected to networked cameras held at positions and controls the shooting direction of the imager built in the cameras according to control data. The controller has a video data detector for extracting motion picture data produced by the predominant camera from motion picture data produced by all of the cameras, and a camera control that corrects control data about the shooting camera with camera control request data entered by the user. The camera control outputs the corrected control data about the shooting camera to the predominant camera and also to the nearby cameras near the predominant camera.

### BACKGROUND OF THE INVENTION

1. Field of the Invention

The present invention relates to a camera controller and, more specifically, to an arrangement, functioning as a server, for controlling networked cameras connected over a telecommunications network to adjust the image-shooting movement of the cameras.

2. Description of the Background Art

Conventionally, a video monitoring camera system, such as a security camera system, has been put into practical use which makes it possible for users to view images captured by plural stationary cameras held at a remote location, such as a nursery, kindergarten, day nursery, on a real-time basis via cellular phones and which permits them to view their interesting part of the location by controlling the PTZ (pan, tilt and zoom) movements of the stationary cameras through manipulation on the cellular phones, as disclosed on the website “Livekids Video Communication System”, IL GARAGE Co., Ltd., searched for on Aug. 26, 2009, Internet,www.livekids.jp/system/index.html.

In such a system, however, a single cellular phone terminal can control one stationary camera only. Therefore, for example, when the subject, such as a child in a kindergarten or nursery, has moved out of the shooting area of one camera under control and entered the shooting area of another camera nearby, it is necessary for the user to manipulate his or her cellular phone for switching the picture from the one camera to the other and then control the other camera so as to shoot the subject by the latter. Thus, there is the problem that much labor is required.

### SUMMARY OF THE INVENTION

It is therefore an object of the invention to provide an arrangement for controlling networked cameras which allows the user to simply control an active camera that is currently shooting a subject so as to render another camera, situated therearound, controlled correspondingly.

In accordance with the present invention, an arrangement for controlling networked cameras held at positions and each having an imager whose shooting direction is controllable in response to control data comprises: a camera controller communicably connected to the networked cameras and including a request data receiver operative in response to request data entered on a user terminal to produce the control data, said camera controller outputting the control data to the cameras; and a video data detector for extracting motion picture data produced by shooting one of the cameras from motion picture data produced by the cameras. The camera controller is so configured that when camera control request data is received from the request data receiver, control data which is used to control the shooting camera is corrected with the camera control request data to be output both to the shooting camera and to nearby cameras located near the former.

In this configuration, the camera controller controls the shooting camera and the nearby cameras located near the former among the plural, networked cameras. When camera control request data is input from the outside, the same control data as used to control the shooting camera is used to control the nearby cameras. Thus, it is possible to substantially align the image-shooting direction between the imagers built in the shooting camera and nearby cameras.

According to the present invention, the shooting direction of the imager built in the shooting camera can be substantially aligned with that of the imagers built in the nearby cameras. Therefore, if the user manipulates his or her communication terminal to switch the picture from the shooting camera to any one of the nearby cameras, a picture can be taken almost at the same angle even after switched. Consequently, it is almost unnecessary to control the nearby camera in addition to the shooting camera.

In the present patent application, the term “predominant camera” is directed to a camera that is active in operation to capture the image of a subject to transmit imagewise data currently under the control of a remote user under the situation where other cameras in the video monitoring camera system are also active but not under the control of that remote user. The predominant camera may sometimes be referred to as an “image-shooting” or just “shooting” camera. The word “shooting” may specifically be comprehended as capturing the image of a subject regardless of motion pictures or still image. The word “movement” of a camera in the context may be directed specifically to the movement of the optics of a camera, such as PTZ movements, which may sometimes be called the attitude, posture or position of a camera, even covering zooming. Focus control may also be included.

### BRIEF DESCRIPTION OF THE DRAWINGS

The objects and features of the present invention will become more apparent from consideration of the following detailed description taken in conjunction with the accompanying drawings in which:

FIG. 1 is schematically shows an illustrative embodiment of a remote image-shooting system including a camera controller in accordance with the present invention;

FIG. 2 is a schematic block diagram of a camera controller included in the illustrative embodiment shown in FIG. 1;

FIGS. 3 and 4 show an exemplified layout of stationary cameras in the embodiment for use in understanding how the PTZ movements thereof are controlled;

FIG. 5 shows an example of data items stored in a nearby camera information storage included in the camera controller shown in FIG. 2;

FIG. 6 shows an example of data items stored in a control data storage included in the camera controller shown in FIG. 2;

FIG. 7 is a flowchart useful for understanding the overall control of the camera controller of the illustrative embodiment;

FIG. 8 is a flowchart useful for understanding a camera selection request data processing routine performed by the camera controller of the embodiment;

FIGS. 9A and 9B are a flowchart useful for understanding a camera control request data processing routine performed by the camera controller;

FIG. 10 is a flowchart useful for understanding a camera switching request data processing routine performed by the camera controller;

FIG. 11 is a schematic block diagram, like FIG. 2, of a camera controller in accordance with an alternative embodiment of the invention;

FIGS. 12 and 13 show, like FIGS. 3 and 4, an exemplified layout of stationary cameras in a remote shooting system in accordance with the alternative embodiment for use in understanding how the PTZ movements thereof are controlled;

FIG. 14 is a flowchart, like FIG. 7, useful for understanding the overall control of the camera controller in accordance with the alternative embodiment shown in FIG. 12;

FIG. 15 is a flowchart useful for understanding a pseudo viewing location data processing routine performed by the camera controller of the alternative embodiment;

FIGS. 16A and 16B are a flowchart, like FIGS. 9A and 9B, useful for understanding a camera control request data processing routine performed by the camera controller of the alternative embodiment;

FIG. 17 shows an exemplified layout of stationary cameras connected with plural communication terminals, wherein nearby cameras are shared by two shooting cameras X adjacent to each other; and

FIG. 18 shows an example of layout of stationary cameras connected to plural communication terminals, wherein one stationary camera set as a nearby camera of a predominant camera controlled by one user is taken as another predominant camera controlled by another user.

### DESCRIPTION OF THE PREFERRED EMBODIMENTS

A preferred embodiment of the present invention will hereinafter be described with reference to some accompanying drawings as appropriate while taking an example in which a camera controller of the present invention is applied to a server in a local telecommunications network, such as a security or video monitoring system installed in a location such as a nursery, kindergarten or day nursery. Like components are indicated by the same reference numerals, and may not repeatedly be described.

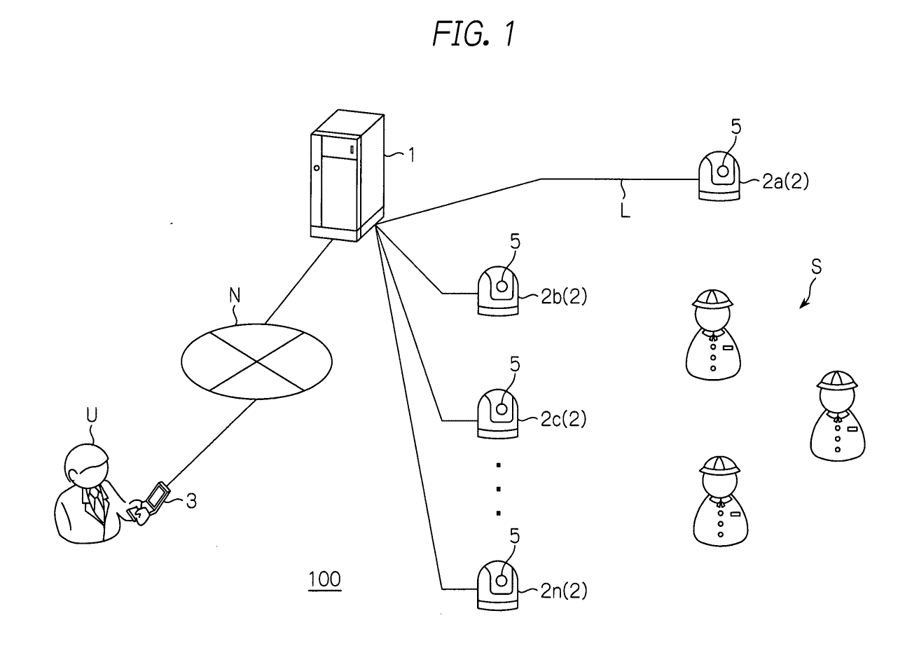

FIG. 1 is a schematic diagram showing a remote image-shooting system such as a security or video monitoring system. As shown in the figure, the remote shooting system, generally indicated by reference numeral 100, has a camera controller 1 functioning as a server installed in local place such as a nursery, a plurality of stationary cameras 2 having a built-in imaging device or imager, not shown, and connected to the camera controller 1 over a telecommunications network N, such as a wired or wireless LAN (local area network), and a communication terminal 3 connected with the camera controller 1 over another telecommunications network N, such as a WAN (wide area network), a wired or wireless LAN, or a telephone network.

The stationary cameras 2 are fixedly installed at arbitrary locations within the nursery, for example, and used to image subjects S such as nursery children to produce motion picture data representing the image thus captured. In the context, the term “stationary” or “static” camera means an imaging unit, e.g. a video camera, substantially immovably situated at a location. The communication terminal 3 receives motion picture data transmitted from the camera controller 1 and visualizes the data on its monitor display, not shown, in the form of motion pictures visible to a user U.

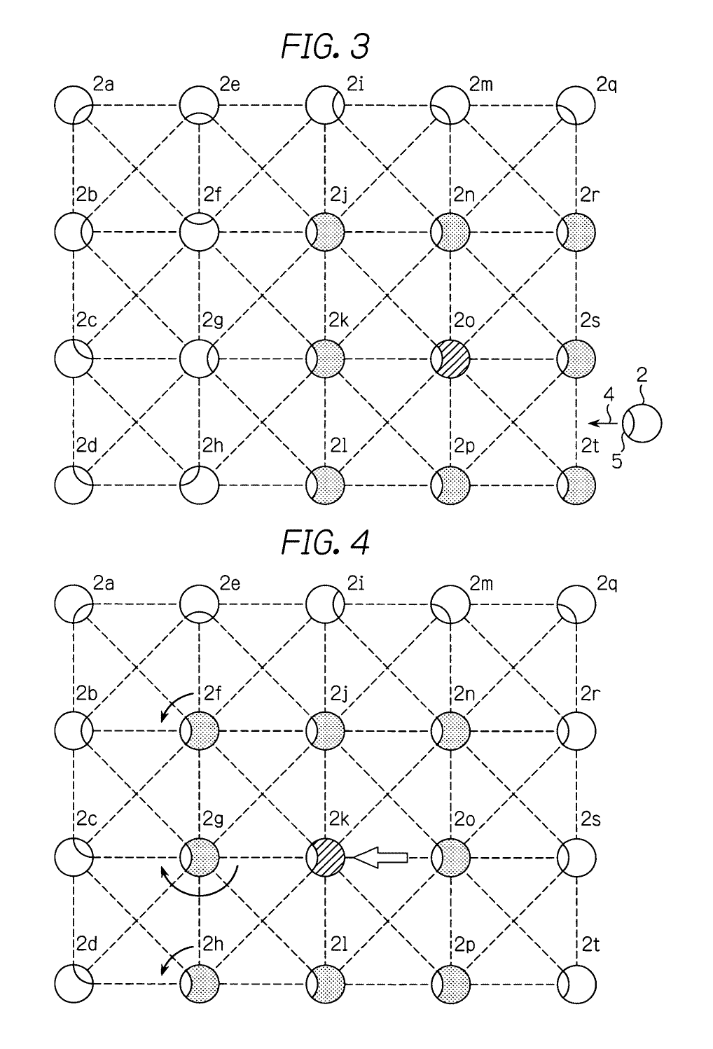

The stationary cameras 2, specifically depicted with reference numerals 2a, 2b, 2c and so on, are fixedly installed in appropriate locations within the nursery premises and connected with the camera controller 1 over the network L such as a LAN. The stationary cameras 2 thus networked may have the same functions as general video cameras. More specifically, the cameras 2 may be adapted to respond to control data supplied from the camera controller 1 to effect at least one of its PTZ (pan, tilt and zoom) movements, i.e. to turn the optical axis 4, FIG. 3, of the imaging lens system 5 left and right and up and down, and to zoom in and out in order to image the subjects S to produce motion picture data representative of the captured image. In the environment of this specific embodiment, the stationary cameras 2a, 2b, 2n may be laid out as shown in FIG. 3. Note that it may be sufficient for the cameras 2 to function as not the entirety but some of the PTZ movements. The cameras 2 may be mounted on a ceiling or on upper portions of partitions that partition off rooms or booths, for example.

The communication terminal 3 may be, e.g. a cellular phone including a smart phone, a telephone handset, and a PDA (personal digital assistant) and a personal computer with telecommunications function. The communication terminal 3 implements, for instance, by means of program sequences loaded and executable on the hardware, its functions of selecting one of the stationary cameras 2, sending camera control request data for controlling the selected camera 2, and reproducing motion picture data received to visualize motion pictures.

The communication terminal 3 is manipulated by the user U and performs corresponding operational steps as described below.

(1) In order to make use of the remote shooting system 100, the communication terminal 3, when manipulated by the user U, displays a menu of choices on the display screen, not shown, to prompt him or her to make a choice from the stationary cameras 2a, 2b, 2n.

(2) The communication terminal 3 permits the user U to select one of the stationary cameras 2 as a selected camera 20.

(3) The communication terminal 3 in turn produces camera selection request data, which may be referred to simply as “request data”, including identification (ID) information on the selected camera 20 (camera ID) and sends the produced information to the camera controller 1 over the network N.

(4) The communication terminal 3 receives motion picture data captured by the selected camera 20 from the camera controller 1, converts the received data into a form visible and audible to the user U, and displays the data on its display screen.

(5) The user U may enter instructions for turning the shooting direction, i.e. direction of the optical axis, 4 of the built-in camera lens 5 of the selected camera 20 up and down and right and left and zooming in and out. The instructions entered at this time may include a pan angle, a tilt angle, a zoom factor or angle, etc. The values thereof may be either values relative to the current values of pan angle, tilt angle and zoom factor, or absolute values of the selected camera 20. With the illustrative embodiment, relative values of pan angle, tilt angle and zoom factor are entered.

(6) The communication terminal 3 in turn produces camera control request data, which may be referred to simply as “request data”, including the entered instructions on the PTZ movements and sends the produced data to the camera controller 1.

(7) The communication terminal 3 receives the motion picture data captured by the selected camera 20 and transmitted through the camera controller 1, converts the data into a form visible and audible to the user U, and displays the data onto the display screen.

(8) The user U may enter an instruction for switching the selected camera 20 to another camera.

(9) The communication terminal 3 in turn produces camera switching request data, which may be referred to simply as the request data, and sends the data to the camera controller 1.

(10) The communication terminal 3 receives motion picture data transmitted from the camera controller 1, converts the data into a form visible and audible to the user U, and displays the data onto the display screen.

Through the routine consisting of the processing steps (1)-(10) described so far, the communication terminal 3 can select any one of the stationary cameras 2 as a selected camera 20 that images the subject S that the user U wants to view. Furthermore, when entering a combination of appropriate instructions, the subject S that is in motion can be traced.

The camera controller 1 is connected to the communication terminal 3 over the network N, and includes a terminal communication portion, not specifically shown, for transmitting and receiving data to and from the communication terminal 3, and a camera communication portion, also not specifically shown, connected to the stationary camera 2 over the network L to transmit and receive data to and from the stationary camera 2. The camera controller 1 acquires or receives request data, including camera selection and control request data, from the communication terminal 3, uses the camera ID of the selected camera 20 included in the camera selection request data to determine a shooting camera X to be used for image-capturing, and provides the shooting camera X with camera control data based on the camera control request data to. Furthermore, in response to the camera switching request data, the controller 1 switches the shooting camera from X to another. The controller 1 receives video data from the respective stationary cameras 2 and transmits the video data coming from the shooting camera X to the communication terminal 3. It is to be note that the term “shooting camera” in the context refers to one of the stationary cameras 2 which is currently active to predominantly capture the image of a subject of interest.

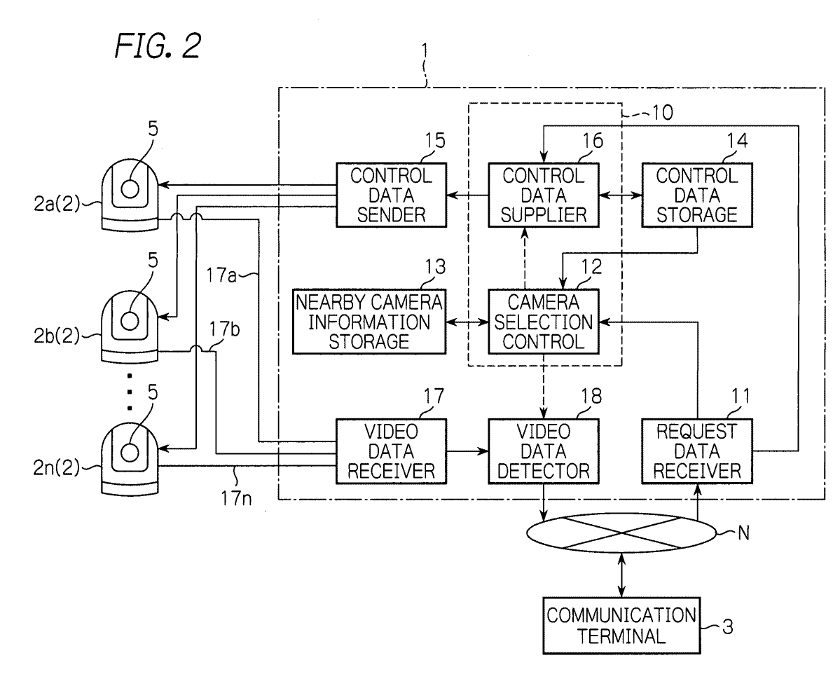

With reference to FIG. 2, the camera controller 1 generally includes a camera control 10, a request data receiver 11, a camera selection control 12, a nearby camera information storage 13, a control data storage 14, a control data sender 15, a video data receiver 17 and a video data detector 18, which are interconnected as illustrated. The camera control 10 includes a camera selection control 12 and a control data supplier 16. In the following, description of the terminal and camera communication portions will be omitted since the details thereof are not relevant to understanding the invention.

The camera controller 1 can be made of a general computer, or processor system, including a CPU (central processing unit), a ROM (read only memory), a RAM (random access memory) and an HDD (hard disc drive), not shown. The illustrative embodiment of the camera controller 1 is depicted and described as configured by separate functional blocks as depicted. It is however to be noted that such a depiction and a description do not restrict the controller 1 to an implementation only in the form of hardware but may at least partially or entirely be implemented by software, namely, by such a computer which has a computer program installed and functions, when executing the computer program, as part of, or the entirety of, the controller 1. That may also be the case with alternative embodiment which will be described later on. In this connection, the word “circuit” may be understood not only as hardware, such as an electronics circuit, but also as a function that may be implemented by software installed and executed on a computer.

The request data receiver 11 is adapted to acquire or receive request data, including camera selection request data, camera control request data and camera switching request data, from the communication terminal 3 and outputs the data thus acquired to a destination component according to the request data. Specifically, if the request data is “camera selection request data”, then the request data receiver 11 outputs the data to the camera selection control 12. If the request data is “camera control request data”, the receiver 11 outputs the data to the camera selection control 12 and the control data supplier 16. On the other hand, if the request data is “camera switching request data”, the receiver 11 outputs the data to the camera selection control 12.

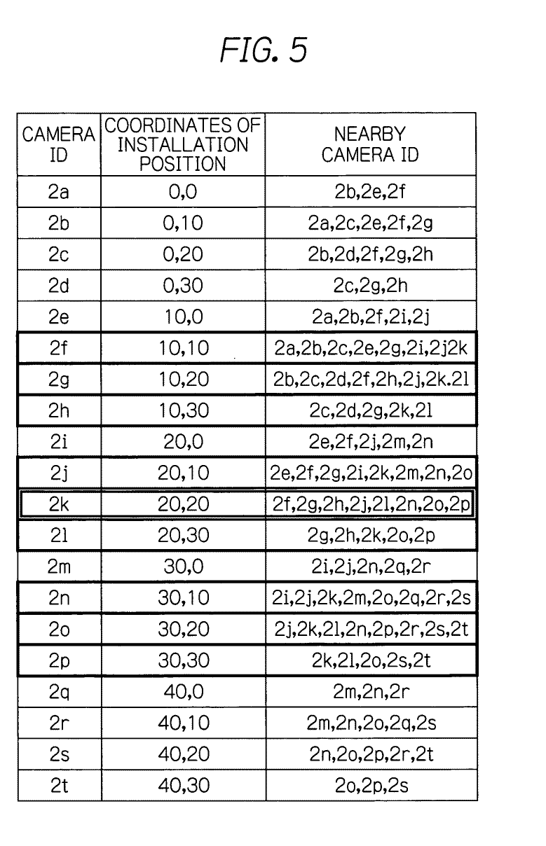

The nearby camera information storage 13 is adapted to store information on camera IDs for identifying specific stationary cameras 2, the coordinates at which the stationary cameras 2 are installed in a location, and the nearby camera IDs identifying cameras 2 set in advance as nearby cameras neighboring a stationary camera 2 in question. These data items are tabularized as shown in FIG. 5 and managed in a single database in the system 100.

The term “nearby camera” in the context refers to one (y) of the stationary cameras 2 which resides adjacently to another (x) of the stationary cameras 2 of interest which can image part of the boundary or edge area of the image-shootable, or service, region of a camera x of interest and its peripheral area neighboring the service region.

In FIG. 3, the broken lines interconnecting the stationary cameras 2 as shown indicate that the cameras thus connected are associated as nearby cameras. For example, stationary camera 2k, when serving as camera x, is associated as its nearby cameras y with eight stationary cameras 2f, 2g, 2h, 2j, 2l, 2n, 2o, and 2p residing therearound.

The camera selection control 12, included in the camera control 10, is adapted to be responsive to request data, i.e. camera selection and control request data, provided from the request data receiver 11 to determine as a shooting camera X a camera for use in image-capturing and outputs the camera IDs of the shooting camera X and its nearby cameras Y associated with the shooting camera X to the control data supplier 16 described later. Furthermore, the selection control 12 outputs the camera ID of the shooting camera X also to the video data detector 18 also described later.

Where camera selection request data is obtained from the request data receiver 11, the camera selection control 12 extracts the identification information, or camera ID, on the selected camera 20 included in the camera selection request data and sets the selected camera 20 as the shooting camera X. The selection control 12 references the data stored in the nearby camera information storage 13 to set some of the stationary cameras 2 associated with the shooting camera X as nearby cameras Y.

For example, with reference to FIG. 4, in a case where the camera selection request data representing a stationary camera 2k as the selected camera 20, i.e. asking for selection of the stationary camera 2k, is obtained from the request data receiver 11, the camera selection control 12 sets the stationary camera 2k as the shooting camera X, namely the stationary camera 2k being a shooting camera X. Furthermore, the selection control 12 uses the data stored in the nearby camera information storage 13 to set as the nearby cameras Y the eight stationary cameras 2f, 2g, 2h, 2j, 2l, 2n, 2o, and 2p associated with the shooting camera X.

In this illustrative embodiment, the camera selection control 12 has a shooting camera ID storage area, not shown. Whenever the shooting camera X shifts to another one of the stationary camera 2, i.e. each time the camera ID of the shooting camera X is reset or updated, the selection control 12 stores, updates, the camera ID of the shooting camera in the shooting camera ID storage area, not shown.

Where camera control request data is obtained from the request data receiver 11, the camera selection control 12 acquires the camera ID of the shooting camera X from the shooting camera ID storage, and uses the data stored in the nearby camera information storage 13 to cause one or some of the stationary cameras 2 associated with the shooting camera X to be set as the nearby camera or cameras Y. The camera selection control 12 produces shooting camera instruction data including the camera ID of the shooting camera X and nearby camera instruction data including the camera IDs of the nearby cameras Y to output the shooting camera instruction data to the control data supplier 16 and the video data detector 18, and to output the nearby camera instruction data to the control data supplier 16.

When the camera switching request data is obtained from the request data receiver 11, the camera selection control 12 acquires control data, indicating a pan angle, associated with the camera ID of the shooting camera X from the shooting camera ID storage area of the control data storage 14.

The camera selection control 12 uses information on the pan angle of the shooting camera X and the coordinates of the installation position of the camera X stored in the nearby camera information storage 13 to fetch from the nearby camera information storage 13 the camera ID of the nearby camera located at a position shifted by the pan angle from the location where the shooting camera X stays. The selection control 12 in turn sets a nearby camera Yx associated with the nearby camera ID as a new shooting camera X. The camera selection control 12 uses the data stored in the nearby camera information storage 13 to set one of the stationary cameras 2 which is associated with the newly set shooting camera X as the nearby camera Y.

Thus, the processing described so far causes the shooting camera X to be switched. That is, the set shooting camera X is switched from one of the stationary cameras 2 to another.

Whenever the shooting camera X and nearby camera Y are set, the camera selection control 12 produces shooting camera instruction data including the camera ID of the set shooting camera X and nearby camera instruction data including the camera ID of the set nearby camera Y. The camera selection control 12 outputs the shooting camera instruction data to the control data supplier 16 and the video data detector 18, and outputs the nearby camera instruction data to the control data supplier 16.

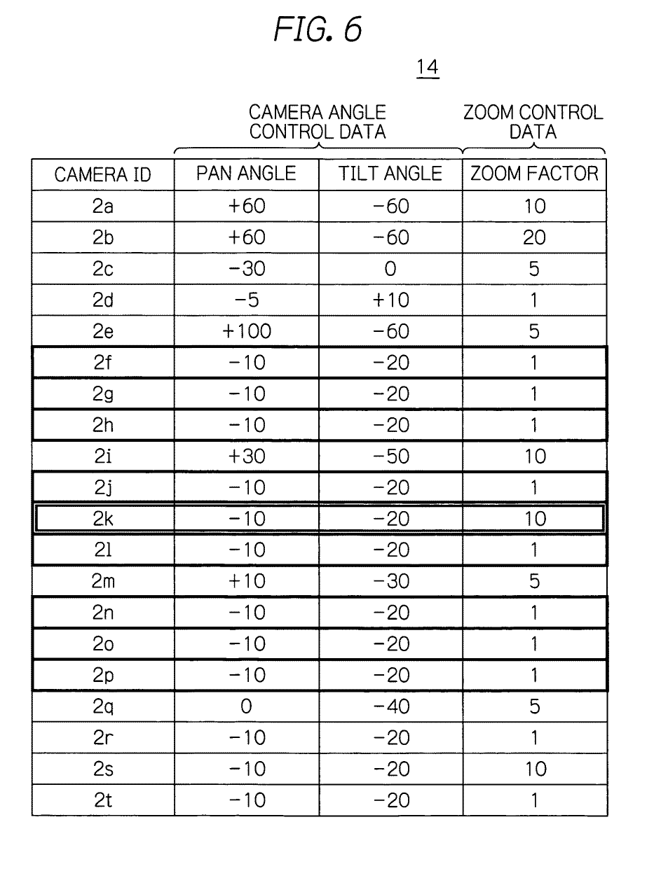

The control data storage 14 stores control data indicating the state of each stationary camera 2. In particular, as shown in FIG. 6, pan angles indicating the angles of directing the lens system 5 to the right and left in the horizontal direction and tilt angles indicating the angles of directing the lens system 5 upward and downward in the vertical direction are stored as camera angle control data indicative of the values of PTZ movements. Besides, zoom factors, or magnifications, are stored which indicate the scale factors of the subject S to be zoomed in and out.

In the control data storage 14 shown in FIG. 6, pan angles taken to the right from a reference point) (0°) are indicated positive while pan angles taken to the left from the reference point are indicated negative. Tilt angles taken upward from the reference point are indicated positive while tilt angles taken downward from the reference point are indicated negative. The control data may be update by the control data supplier 16 described later.

The control data sender 15 is adapted for acquiring camera IDs and control data from the control data supplier 16 to output the control data to the stationary camera 2 associated with the camera ID.

The control data supplier 16, included in the camera control 10, functions as obtaining instruction data, such as shooting camera instruction data and nearby camera instruction data, from the camera selection control 12, and storing control data obtained through processing responsive to the instruction data into the control data storage 14 and outputting the data to the control data sender 15.

In operation, first, the control data supplier 16 receives shooting camera instruction data from the camera selection control 12. The control data supplier 16 then extracts the camera ID of the shooting camera X included in the shooting camera instruction data, and obtains control data associated with the camera ID from the control data storage 14.

The control data supplier 16 determines whether or not camera control request data can be obtained from the request data receiver 11. In this determination, if camera control request data is output from the request data receiver 11, the control data supplier 16 can then acquire the camera control request data. If the camera control request data is successfully acquired, the control data supplier 16 then corrects the control data with the camera control request data, i.e. control data±camera control request data, and calculates new control data about the shooting camera X, i.e. shooting camera control data.

In the determination made by the control data supplier 16, if camera control request data is not obtained, the control data acquired from the control data storage 14 is taken as shooting camera control data by the control data supplier 16. Then, the control data supplier 16 associates the shooting camera control data with the camera ID of the shooting camera X and stores the data in the control data storage 14.

Then, the control data supplier 16 receives nearby camera instruction data from the camera selection control 12. The control data supplier 16 then extracts the camera IDs of all the nearby cameras Y included in the nearby camera instruction data, and associates the shooting camera control data with the camera IDs of the respective nearby cameras Y to store the data in the control data storage 14. This processing is performed for all the nearby cameras Y indicated by the nearby camera instruction data.

The control data supplier 16 then outputs the camera IDs extracted from the shooting camera instruction data and nearby camera instruction data to the control data sender 15, as well as the shooting camera control data.

The processing performed by the control data supplier 16 as described so far causes the control data storage 14 to store, as shown in FIG. 6, camera angle control data indicating coincidence in tilt and pan angles, representing the camera attitude (shooting direction), among the shooting camera X (stationary camera 2k in this example) and all the nearby cameras Y (stationary cameras 2f, 2g, 2h, 2j, 2l, 2n, 2o, and 2p).

Now, returning to FIG. 2, the video data receiver 17 is configured to receive video data transmitted from the respective stationary cameras 2. The video data receiver 17 may have a storage or buffer area for temporarily storing the video data thus received.

The video data detector 18 is configured to receive the shooting camera instruction data from the camera selection control 12 to extract the camera ID of the shooting camera X from the instruction data, and to receive video data delivered from the stationary camera 2 associated with the camera ID thus extracted on the video input ports 17a, . . . , 17n to output the video data to the communication terminal 3.

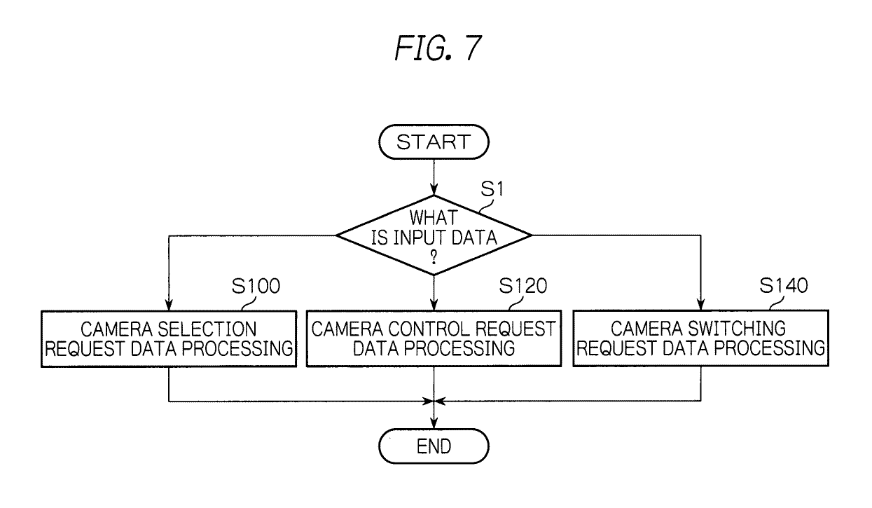

The detailed operation of the camera controller 1 will be described by referring to the flowcharts of FIGS. 7-10 and also to FIGS. 1-6 as appropriate. As illustrated in FIG. 7, a decision is made as to whether or not there is data input from the communication terminal 3, when manipulated by the user U, and what the data is when received (step S1). According to the data, one of processing routines, i.e. camera selection request data processing routine S100, camera control request data processing routine S120, and camera switching request data processing routine 5140, is selected.

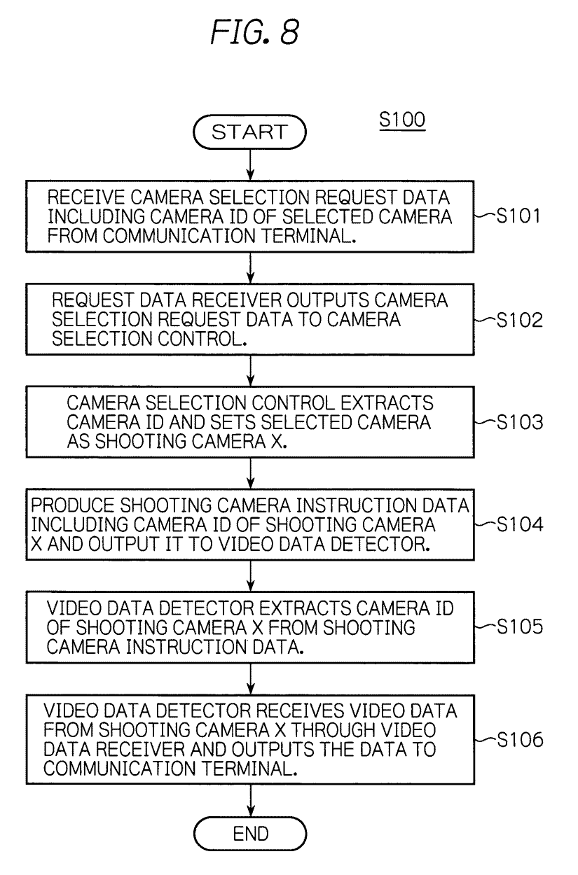

FIG. 8 illustrates in detail the camera selection request data processing routine S100, FIG. 7. First, the camera controller L receives the camera selection request data including the identification information (camera ID) about the selected camera 20 from the communication terminal 3 manipulated by the user U (step S101). The request data receiver 11 outputs the received camera selection request data to the camera selection control 12 (step S102).

The camera selection control 12 receives the camera selection request data from the request data receiver 11, and extracts the identification information (camera ID) about the selected camera 20 included in the camera selection request data to set the selected camera 20 as the shooting camera X (step S103). Then, the camera selection control 12 stores the camera ID of the shooting camera X into the shooting camera ID storage area, not shown. The camera selection control 12 then produces shooting camera instruction data including the camera ID of the set shooting camera X, and outputs the data to the video data detector 18 (step S104).

The video data detector 18 thus receives the shooting camera instruction data from the camera selection control 12 and extracts the camera ID of the shooting camera X (step S105). The extractor 18 then obtains video data delivered from the stationary camera 2 (selected camera 20) associated with the camera ID from the video data receiver 17, and outputs the video data to the communication terminal 3 (step S106). Consequently, the user U can view and listen to the motion pictures displayed on the display screen, not shown, of the communication terminal 3.

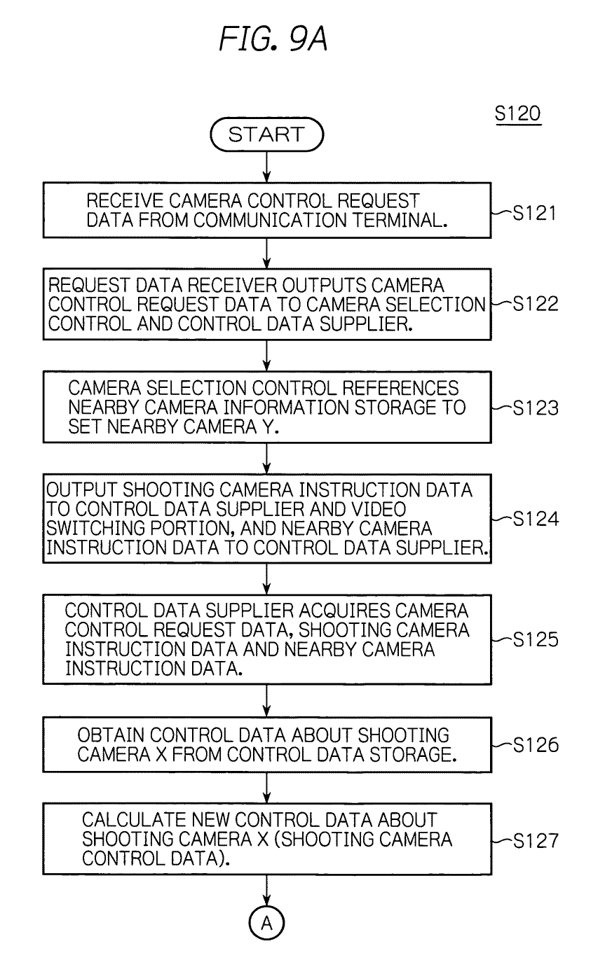

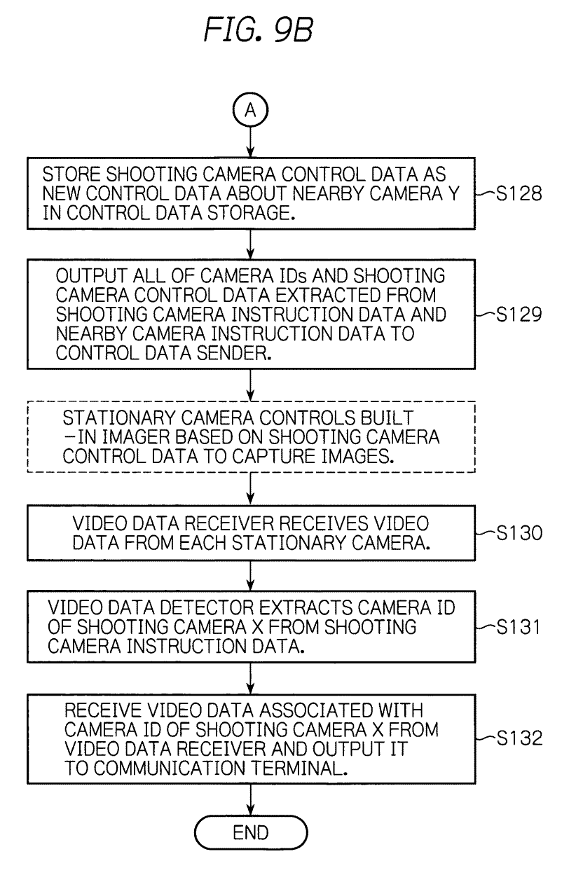

FIGS. 9A and 9B illustrate in detail the camera control request data processing routine S120, FIG. 7. First, the camera controller 1 receives camera control request data from the communication terminal 3, when manipulated by the user U (step S121). The request data receiver 11 outputs the received camera control request data to the camera selection control 12 and the control data supplier 16 (step S122).

The camera selection control 12 receives the camera control request data from the request data receiver 11 and uses the data stored in the nearby camera information storage 13 to thereby set the stationary camera 2 associated with the shooting camera X as the nearby camera Y (step S123).

The camera selection control 12 produces the shooting camera instruction data and nearby camera instruction data to output the shooting camera instruction data to the control data supplier 16 and the video data detector 18, and to output the nearby camera instruction data to the control data supplier 16 (step S124).

The control data supplier 16 receives the camera control request data from the request data receiver 11 and further gains shooting camera instruction data and nearby camera instruction data from the camera selection control 12 (step S125). Then, the control data supplier 16 extracts the camera ID of the shooting camera X from the shooting camera instruction data and utilizes the camera ID of the shooting camera X to acquire the control data about the shooting camera X from the control data storage 14 (step S126).

The control data supplier 16 then corrects the control data about the shooting camera X with the camera control request data, i.e. control data±camera control request data, and calculates new control data about the shooting camera X, i.e. shooting camera control data (step S127).

Through a connector A in FIGS. 9A and 9B, the control data supplier 16 then extracts the camera IDs of all the nearby cameras Y included in the nearby camera instruction data, and associates the shooting camera control data with the respective camera IDs to store the shooting camera control data as new control data about the nearby cameras Y in the control data storage 14 (step S128).

The control data supplier 16 outputs all the camera IDs extracted from the shooting camera instruction data and nearby camera instruction data to the control data sender 15, together with the shooting camera control data (step S129). In turn, the shooting camera control data will be transmitted to the stationary cameras 2 associated with all the camera IDs extracted from the shooting camera instruction data and nearby camera instruction data by the control data sender 15.

One or ones of the stationary cameras 2, when having received the shooting camera control data, are responsive to the shooting camera control data to control on the built-in imaging system to thereby shoot the subject S in question. The video data thus produced by the cameras 2 will be transmitted to the video data receiver 17 of the camera controller 1.

The video data receiver 17 receives the video data from respective individual stationary cameras 2 (step S130). The video data detector 18 extracts the camera ID of the shooting camera X from the shooting camera instruction data received from the camera selection control 12 (step S131). The video data detector 18 acquires the video data delivered from the stationary camera 2 thus associated with the camera ID of the shooting camera X from the video data receiver 17 and outputs the video data to the communication terminal 3 (step S132). Consequently, the user U can watch and listen to the motion pictures displayed on the display screen of the communication terminal 3.

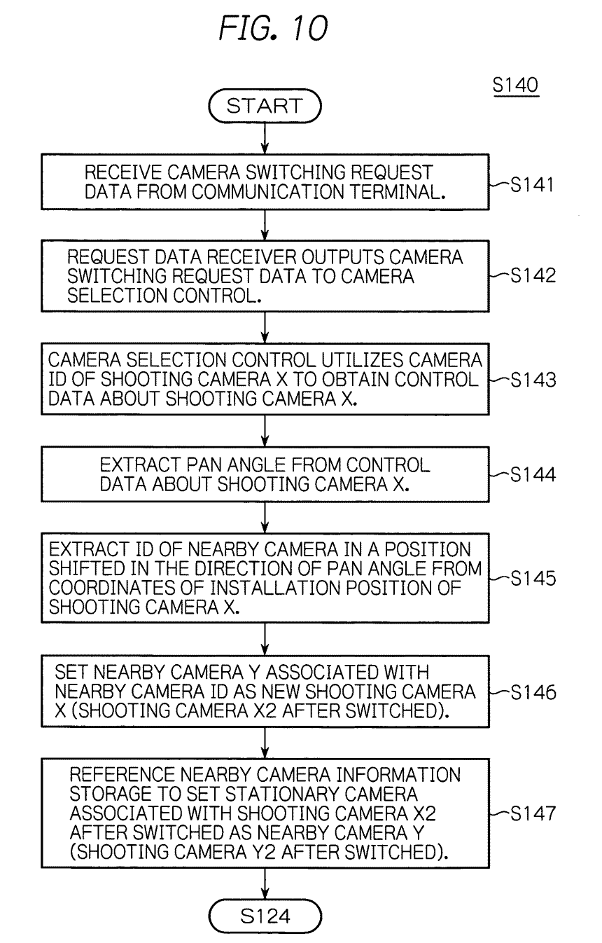

Now, FIG. 10 illustrates more in detail the camera switching request data processing routine S140, FIG. 7. The camera controller 1 receives the camera switching request data from the communication terminal 3, when manipulated by the user U (step S141). The request data receiver 11 outputs the received camera switching request data to the camera selection control 12 (step S142).

The camera selection control 12 utilizes the camera ID of the shooting camera X to thereby obtain control data about the shooting camera X from the control data storage 14 (step S143). Here, the camera ID of the shooting camera X can be acquired from the shooting camera ID storage area, not shown.

The camera selection control 12 extracts the pan angle from the control data about the shooting camera X (step S144). The control 12 uses the pan angle of the shooting camera X and the coordinates of the installation position stored in the nearby camera information storage 13 to fetch the camera ID of the nearby camera or cameras residing in the direction of the pan angle with respect to the shooting camera X (step S145).

Then, the camera selection control 12 sets the nearby camera Y associated with the nearby camera ID as new shooting camera X, which may be referred to shooting camera X₂, after switched, (step S146) and stores the ID in the shooting camera ID storage area, not shown.

The camera selection control 12 uses data stored in the nearby camera information storage 13 to thereby set the stationary camera 2 thus associated with the shooting camera X₂, thus switched, as the nearby camera Y (step S147). The nearby camera after switched may be indicated with Y₂.

Thus, the processing described so far allows the shooting camera X to be switched. That is, the image-shooting camera, i.e. predominant camera, X is switched from the initially used one of the stationary cameras 2 to another.

The camera selection control 12 will then proceed to processing step S124, FIG. 9A. Then, when processing proceeds to step S132, video data output from the shooting camera X₂, after switched, is output to the communication terminal 3. That allows the user U to view and listen to motion pictures displayed on the display screen of the communication terminal 3.

Through the operations described so far, the camera controller 1 of the instant embodiment uses control data about the shooting camera X to store control data about the nearby camera Y in the control data storage 14 (step S128, FIG. 9B). Thus, the stationary camera 2 serving as the nearby camera Y controls its built-in imager with the same control data as used for the shooting camera X, thus rendering the imager built in the shooting camera X substantially identical in shooting direction with the imager built in the nearby camera Y.

The camera controller 1 of the embodiment, when having received the camera switching request data, proceeds to the processing steps S145-S147, FIG. 10, through which the nearby camera Y having its image-shooting direction oriented at the pan angle substantially equal to that of the shooting camera X is set as a new shooting camera X so as to facilitate the shooting camera to be switched between cameras whose built-in imagers have the same shooting direction as each other. Consequently, the images of the subject of interest can be taken at substantially the same viewing angle throughout the camera switching. Accordingly, it is almost unnecessary for the user to control the new shooting camera X after switched.

An alternative embodiment of the present invention will hereinafter be described by referring to some figures of the accompanying drawings as appropriate. As stated earlier, like components are designated with the same reference numerals, and repetitive description thereon will be refrained from just for simplicity.

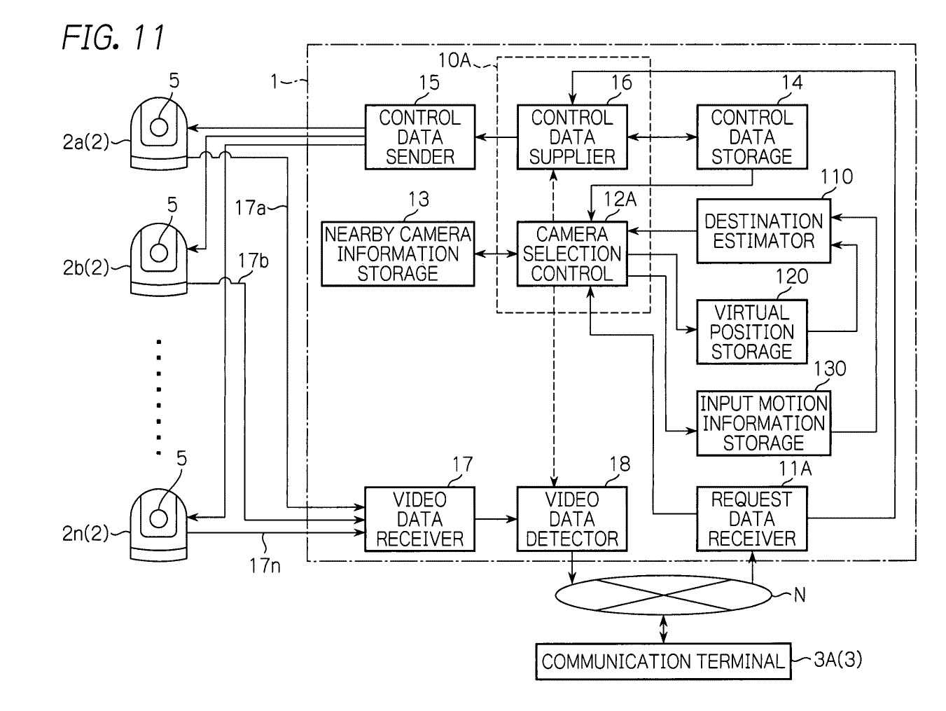

With reference to FIG. 11, the remote image-shooting system 100 may include a communication terminal 3A, when manipulated by the user U, performs the same operational steps as described earlier in connection with the communication terminal 3, FIG. 2, except the steps (1) (2) and (3), which will be described below.

(1) In order to make use of the remote shooting system 100, the communication terminal 3A, when manipulated by the user U, displays on its monitor display a screen to prompt him or her to enter information on the coordinates and direction of a virtual viewing location.

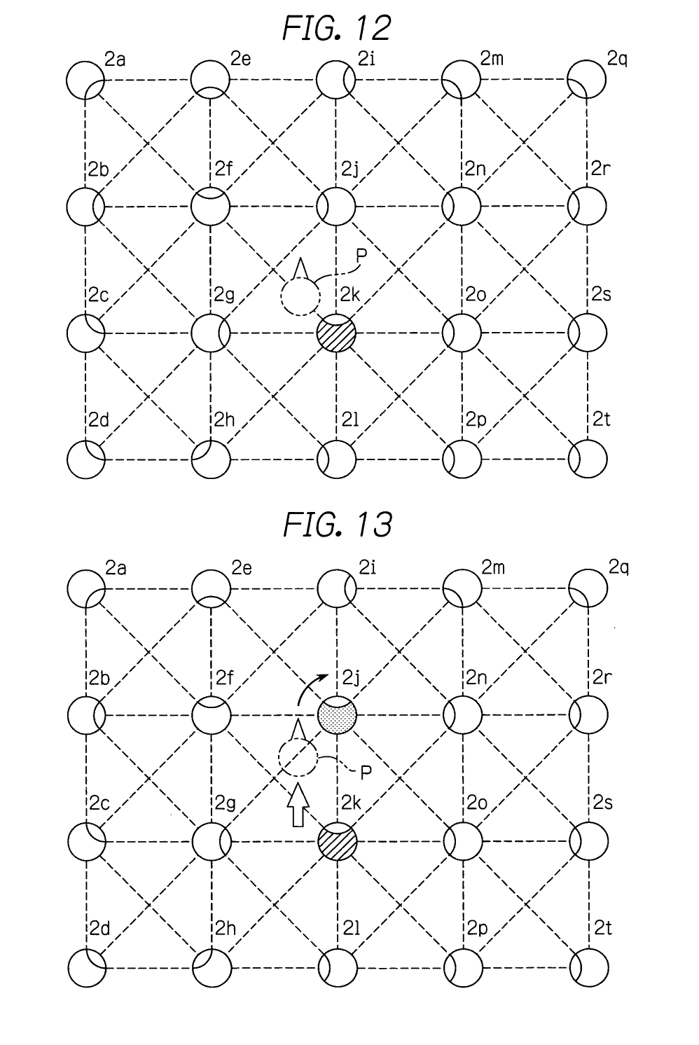

(2) The communication terminal 3A then receives from the user U information indicating that a virtual person P, FIGS. 12 and 13, stands at some location, i.e. the coordinates of the virtual viewing location and watches in some direction from the virtual viewing location. Such information may be predetermined on location and direction, which may be displayed on the communication terminal 3A and selectively designated by the user U.

(3) The communication terminal 3A produces virtual, or pseudo, viewing location data including the entered coordinates of the virtual viewing location and camera control request data including the entered direction of the virtual viewing location and sends the set of data to the camera controller 1. The request data includes the pseudo viewing location data and the camera control request data.

At this time, the communication terminal 3A produces camera control request data including a zoom factor, and pan and tilt angles. The zoom factor may be obtained from a manipulation for zooming in and out to move the virtual person back and forth accordingly. The pan and tilt angles may be obtained from manipulations for turning the optical axis 4 of the camera lens 5 up and down and right and left.

As seen from FIG. 11, the camera controller 1A of the alternative embodiment may be the same in configuration as the camera controller 1 of the illustrative embodiment shown in and described with reference to FIG. 2 except that the camera controller 1A includes a request data receiver 11A and a camera selection control 12A which may be different in configuration and processing from the request data receiver 11 and the camera selection control 12, respectively. The unit 1A additionally includes a destination estimator 110, a virtual position storage 120, and an input motion information storage 130, which are interconnected as depicted.

The request data receiver 11A is adapted to acquire the request data, including pseudo viewing location data, camera control request data, or camera switching request data, from the communication terminal 3A and, if the request data is pseudo viewing location data, output the data to the camera selection control 12A. The request data receiver 11A may operate similarly to the request data receiver 11 of the embodiment shown in FIG. 2 except that pseudo viewing location data is entered. Therefore, repetitive description will be omitted.

The camera selection control 12A, included in the camera control 10A, is adapted to use the request data, i.e. pseudo viewing location data, camera control request data and camera switching request data, from the request data receiver 11A to place a virtual person according to the pseudo viewing location data, determine a shooting camera X that should perform image-shooting from the position and direction, and estimate a destination of the virtual person on the basis of the camera control request data to set one of the stationary cameras 2 which is located closest to the estimated destination as the nearby camera Y.

In operation, when pseudo viewing location data is received from the request data receiver 11A, the camera selection control 12A of the camera control 10A extracts the coordinates of a virtual viewing location included in the pseudo viewing location data, and fetches from the nearby camera information storage 13 a camera ID associated with the coordinates of an installation position closest to the coordinates of the virtual viewing location to set the camera having this camera ID as the shooting camera X and store data about the set camera into the shooting camera ID storage area, not shown. The camera selection control 12A stores the coordinates of the virtual viewing location in the virtual position storage 120.

Then, the camera selection control 12A produces shooting camera instruction data including the camera ID of the set shooting camera X and outputs the shooting camera instruction data to the control data supplier 16 and the video data detector 18.

The camera selection control 12A obtains a zoom factor, and pan and tilt angles from the camera control request data entered from the request data receiver 11A, and calculates the distance traveled (travel distance) corresponding to the zoom factor. The selection control 12a makes the travel distance, and pan and tilt angles associated with the camera ID of the shooting camera X to store the resultant data in the input motion information storage 130.

The camera selection control 12A further obtains the coordinates of the virtual viewing location from the virtual position storage 120, and calculates the coordinates of a new virtual viewing location that is shifted from the coordinates of the current virtual viewing location by the travel distance in a direction indicated by the pan and tilt angles to store the coordinates of the new virtual viewing location into the virtual position storage 120.

Additionally, the camera selection control 12A acquires the estimated position of the destination as the coordinates of the estimated position from the destination estimator 110 described later, and obtains a camera ID associated with the coordinates of an installation position closest to the coordinates of the estimated position from the nearby camera information storage 13 to set the camera having this camera ID as the nearby camera Y.

In the example shown in FIG. 12, the camera selection control 12A, when having acquired data of the pseudo viewing location P from the request data receiver 11A, sets the stationary camera 2k as the shooting camera X, and stores data about the set camera into the shooting camera ID storage area, not shown. Then, the camera selection control 12A obtains the coordinates of the estimated position derived from the destination estimator 110 and sets the stationary camera 2j of the camera ID as the nearby camera Y, the camera ID of the camera 2j associated with the coordinates of the installation position closest to the coordinates of the estimated position.

Now, with reference to FIG. 11 again, the destination estimator 110 is operative in response to an update of the data stored in the input motion information storage 130 to acquire a predetermined number of data items about the distance traveled, and pan and tilt angles as well as the camera ID of the shooting camera X from the input motion information storage 130.

Then, the destination estimator 110 determines whether or not the last updated, i.e. newest, camera ID and pan angle of the shooting camera X agree with the previously updated camera ID and pan angle of the shooting camera X. The destination estimator 110 of the present alternative embodiment is adapted to compare the last updated data with the immediately previously updated data. Alternatively, comparison may be carried out of the predetermined number of data items derived from the input motion information storage 130 with the last updated data. The determination in comparison may not be made by using only pan angles, but solely using distances traveled. Furthermore, the determination in comparison may be made in terms of all of distance traveled, and pan and tilt angles. In addition, the determination in comparison maybe made in terms of two or more data items of distance traveled, pan and tilt angles.

If the decision indicates a coincidence, the destination estimator 110 acquires the coordinates of the virtual viewing location from the virtual position storage 120. The estimator 110 outputs the estimated position of the destination to the camera selection control 12A, the destination being shifted by the travel distance from the coordinates of the virtual viewing location in a direction indicated by the last updated pan and tilt angles obtained from the input motion information storage 130 together with the last updated camera ID of the shooting camera X. Otherwise, namely, if the decision indicates no coincidence, then the destination estimator 110 performs nothing.

The virtual position storage 120 serves as storing the coordinates of the virtual viewing location entered from the camera selection control 12A.

The input motion information storage 130 is adapted to store the camera ID of the shooting camera X, and distance traveled, pan and tilt angles entered from the camera selection control 12A associatively with each other.

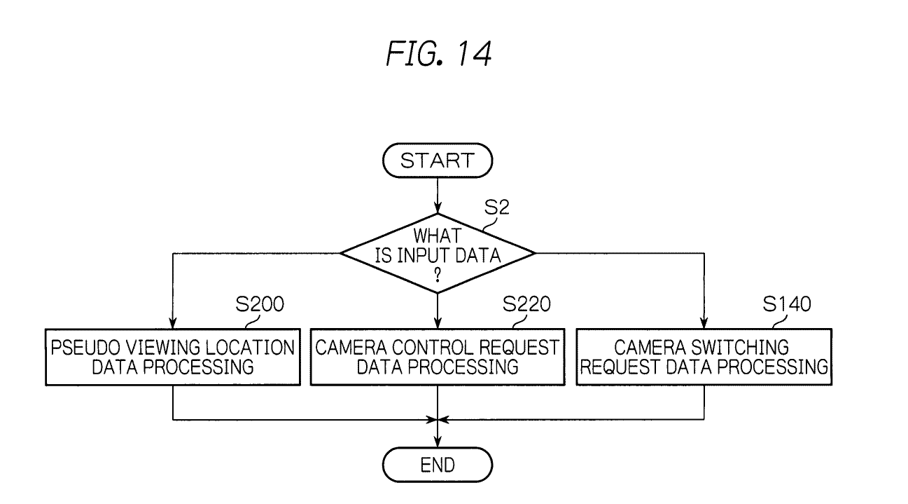

The operation of the camera controller 1A will be described by referring to the flowcharts of FIGS. 14, 15 and 16 and also to FIGS. 1-13 as appropriate. As illustrated in FIG. 14, the camera controller 1A waits for data input from the communication terminal 3A when manipulated by the user U, and determines what the data is when received (step S2). Then, control proceeds to a pseudo viewing location data processing routine S200, a camera control request data processing routine S220, or a camera switching request data processing routine S140.

Since the camera switching request data processing routine performed by the camera controller 1A may be the same as the processing routine done by the camera controller 1 of the embodiment shown in FIG. 2, its repetitive description is omitted. Similarly, processing steps identical with those of the camera controller 1 will not repetitively be described.

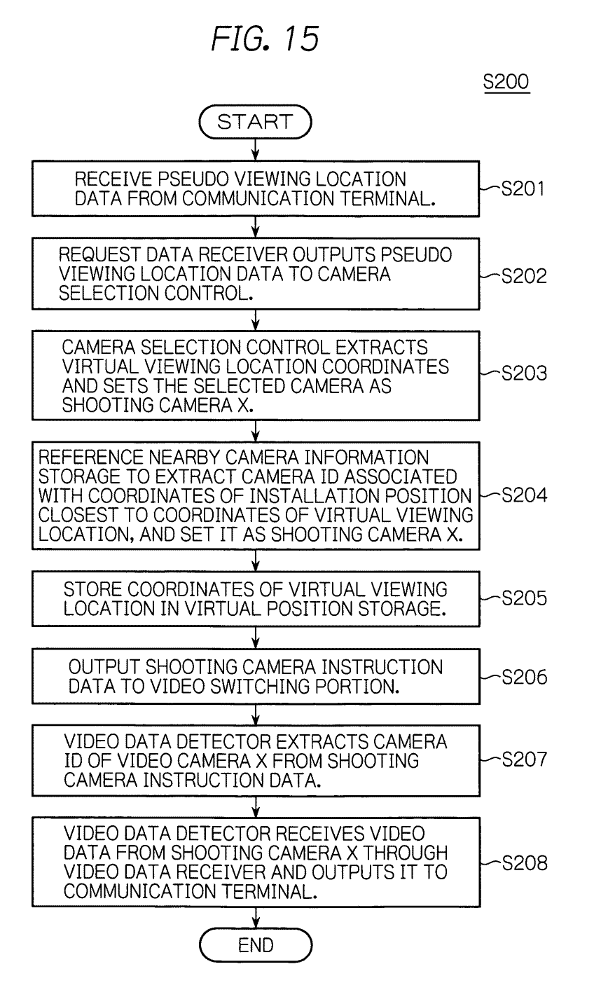

The pseudo viewing location data processing routine S200 is illustrated in FIG. 15 in more detail. The camera controller 1A receives pseudo viewing location data from the communication terminal 3A when manipulated by the user U (step S201). The request data receiver 11A outputs the received pseudo viewing location data to the camera selection control 12A (step S202).

The camera selection control 12A receives the pseudo viewing location data from the request data receiver 11A and extracts the coordinates of a pseudo viewing location included in the pseudo viewing location data (step S203). Furthermore, the control obtains from the nearby camera information storage 13 the camera ID associated with the coordinates of the installation position closest to the coordinates of the pseudo viewing location and sets the camera of this camera ID as the shooting camera X (step S204). The camera selection control 12A stores the camera ID of the shooting camera X into the shooting camera ID storage area, not shown.

Then, the camera selection control 12A stores the coordinates of the pseudo viewing location into the virtual position storage 120 (step S205). The control 12A then produces shooting camera instruction data including the camera ID of the set shooting camera X and outputs the data to the video data detector 18 (step S206).

The video data detector 18 receives the shooting camera instruction data from the camera selection control 12A and extracts the camera ID of the shooting camera X (step S207). The extractor 18 then obtains video data delivered from the stationary camera 2 associated with the camera ID from the video data receiver 17 and outputs the video data to the communication terminal 3 (step S208).

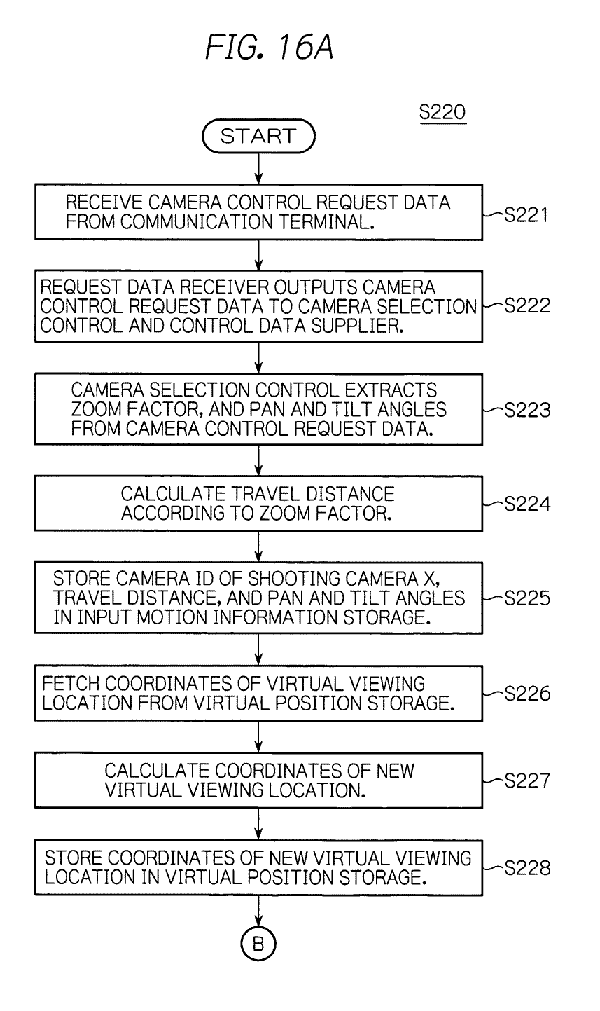

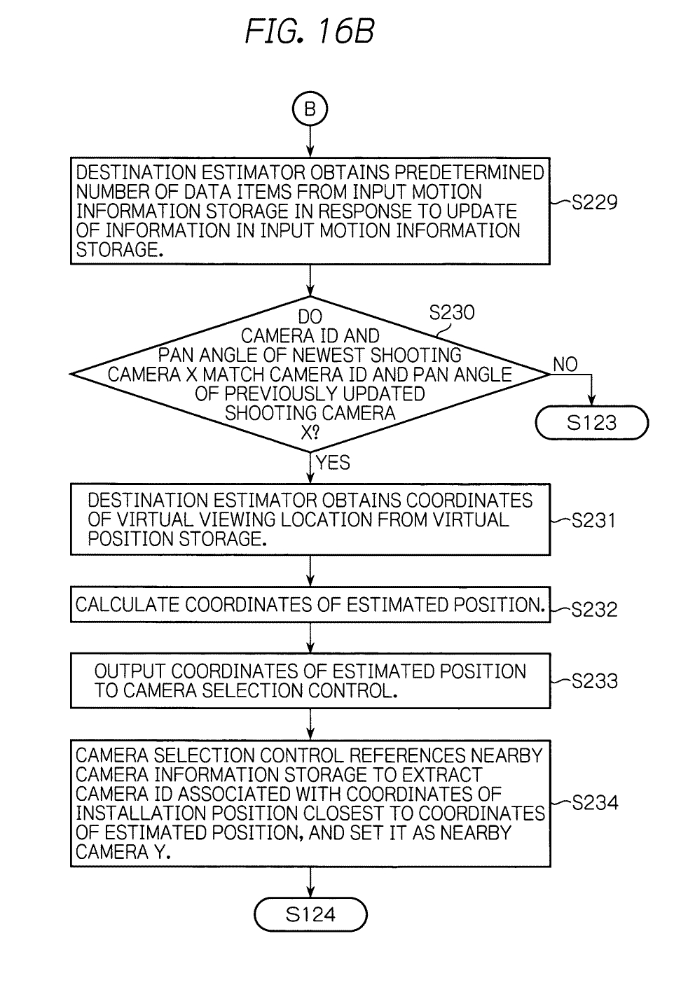

The camera control request data processing routine S220, FIG. 14, is illustrated in FIGS. 16A and 16B in more detail. The camera controller 1A receives camera control request data from the communication terminal 3A, when manipulated by the user U (step S221). The request data receiver 11A outputs the received camera control request data to the camera selection control 12A and the control data supplier 16 (step S222).

The camera selection control 12A obtains camera control request data from the request data receiver 11A, and extracts the zoom factor, and pan and tilt angles from the camera control request data (step S223) to calculate a travel distance corresponding to the zoom factor (step S224). The control 12A stores the travel distance, and pan and tilt angles interrelated with each other into the input motion information storage 130, together with the camera ID of the shooting camera X (step S225).

The camera selection control 12A further acquires the coordinates of the virtual viewing location from the virtual position storage 120 (step S226), and calculates the coordinates of a new virtual viewing location shifted from the coordinates of the aforementioned virtual viewing location by the travel distance in a direction indicated by the pan and tilt angles (step S227), the coordinates of the new virtual viewing location being in turn stored in the virtual position storage 120 (step S228).

Through a connector B in FIGS. 16A and 16B, the destination estimator 110, when the data stored in the input motion information storage 130 is updated, acquires the predetermined number of data items of distance traveled, and pan and tilt angles, as well as the camera ID of the shooting camera X from the input motion information storage 130 (step S229).

Then, the destination estimator 110 determines whether or not the camera ID and pan angle of the last updated, i.e. newest, shooting camera X are coincident with the camera ID and pan angle of the previously updated shooting camera X (step S230). In this example, the destination estimator 110 compares the last updated data (newest data) with the immediately previously updated data.

If the decision indicates no match (No at step S230), the destination estimator 110 terminates its processing routine. Then, the camera selection control 12A will perform the processing routine S123, FIG. 9A, described on the embodiment shown in FIG. 2.

Otherwise, in step S230, namely if the decision indicates that a match is found (Yes), then the destination estimator 110 gets the coordinates of a virtual viewing location from the virtual position storage 120 (step S231). Then, the estimator 110 computes an estimated position of a destination, i.e. coordinates of an estimated position, shifted from the coordinates of the former virtual viewing location by the travel distance in the direction indicated by the pan and tilt angles with the newest data (camera ID, distance traveled, and pan and tilt angles of the newest shooting camera X) obtained from the input motion information storage 130 (step S232) and outputs the computed position to the camera selection control 12A (step S233).

The camera selection control 12A, upon receiving the coordinates of an estimated position from the destination estimator 110, obtains a camera ID associated with the coordinates of the installation position closest to the coordinates of the estimated position from the nearby camera information storage 13, and sets the camera having this camera ID as the nearby camera Y (step S234).

The camera selection control 12A will then perform a processing routine S124, FIG. 9A. During the processing at step S132, video data delivered from the shooting camera X is output to the communication terminal 3.

Through the operation described so far, if the decision at step S230 is positive, Yes, i.e. the input of the same camera control request data from the communication terminal 3A is repeated more than the predetermined number of times, two times with the present alternative embodiment, then the camera controller 1A of the alternative embodiment can set only one camera as the nearby camera Y. Therefore, the camera controller 1A of the alternative embodiment can set and control no more than one camera as nearby camera Y unlike the camera controller 1 of the embodiment shown in FIG. 2. Consequently, burden on the camera controller 1A such as for data processing is alleviated.

In the illustrative embodiments described above, the single communication terminal 3 or 3A is connected to the camera controller 1 or 1A. The camera controller 1 or 1A may be so configured that it is connectable to plural communication terminals 3 or 3A. Where a connection is made to plural communication terminals 3 or 3A, the camera controller 1 or 1A may be adapted to discriminate sets of request data from the communication terminals 3 or 3A with information such as IP (Internet protocol) addresses for identifying destinations to proceed to processing.

When connected to plural terminals 3 or 3A and two stationary cameras controlled as shooting cameras X by different users U, the camera controller 1 or 1A may use information on which of the users U first used the remote shooting system 100, when setting the nearby camera Y, to determine the priority between the users U, and sets as the nearby camera Y a camera neighboring the shooting camera X controlled by one of the users U who is higher in priority.

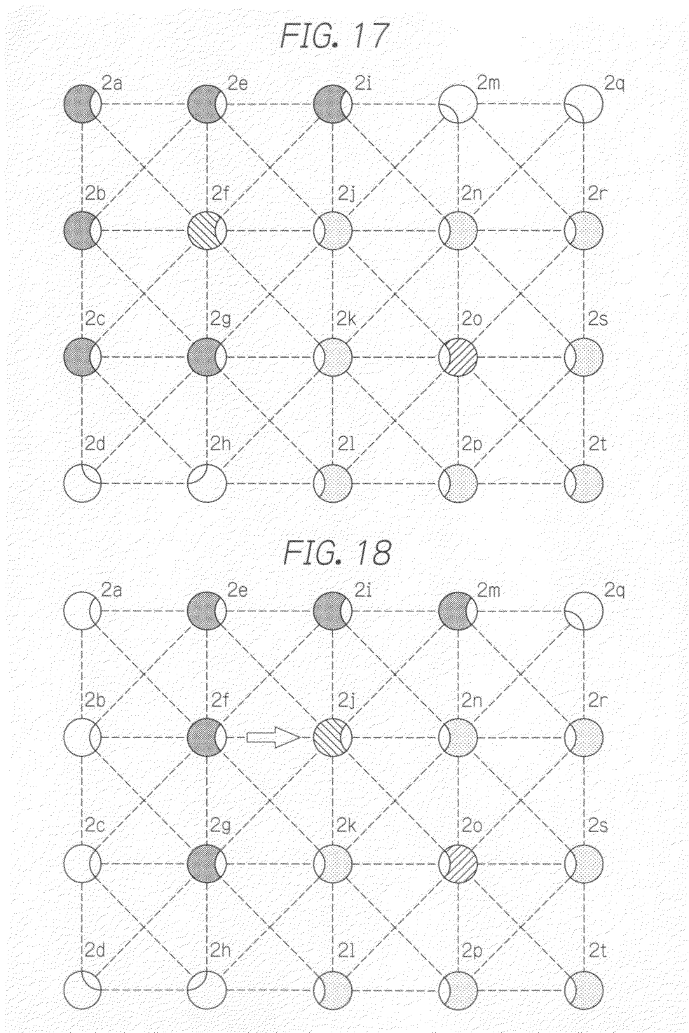

For example, as shown in FIG. 17, when a user U1 controls a stationary camera 2o as the shooting camera X and another user U2 controls a stationary camera 2f as a shooting camera X, the stationary cameras 2j and 2k that are shared as nearby cameras between the stationary cameras 2f and 2o result in being set as nearby cameras Y for the stationary camera 2o controlled by the user U1 higher in priority. The camera controller 1, more specifically the camera selection control 12, obtains the camera IDs of stationary cameras 2 set as shooting cameras X from the shooting camera ID storage area, not shown, as well as the nearby camera IDs of the shooting cameras X from the nearby camera information storage 13 to thereby know one or ones of the nearby cameras Y which is or are currently shared by both users.

When a camera switching is performed such that a stationary camera a serving as a nearby camera for the shooting camera X controlled by the user U1 of the higher priority is changed to a shooting camera X2 used by the other user U2 of the lower priority, the stationary camera a will be set as the shooting camera X2 by the camera selection control 12, irrespective of the priority.

More specifically, for example, as seen from FIG. 17, the user U1 of the higher priority uses the stationary camera 2o as shooting camera X1 and the user U2 of the lower priority uses the stationary camera 2f as shooting camera X2. The stationary camera 2j is treated as a nearby camera, i.e. stationary camera α, for the shooting camera X1. As shown in FIG. 18, in a case where the user U2 of the lower priority operates to switch the shooting camera X2 to the stationary camera 2j (stationary camera a), the camera controller 1 or 1A, when received the camera switching request data for the switching operation, updates the control data about the stationary camera 2j to the control data about the stationary camera 2f, which will be stored in the control data storage 14, thus switching the shooting camera from X2 to the stationary camera 2j.

As described so far, through the processing in which the camera selection control 12 or 12A assigns the users U to priorities, according to which it is determined how the cameras are controlled in priority, the camera controller 1 or 1A can even control plural users U when connected.

The camera controller 1A of the alternative embodiment may further be adapted to store in the nearby camera information storage 13 data representative of the shooting area of each stationary camera 2 with respect to the coordinates of installation positions of the stationary cameras 2 as reference points. In that case, the camera selection control 12A obtains the estimated position of a destination as the coordinates of the estimated position from the destination estimator 110, and thereafter compares the coordinates of the estimated position with those of the shooting areas of all the stationary cameras 2 stored in the nearby camera information storage 13. The selection control 12A may then determine the camera IDs of the stationary cameras 2 having the shooting areas thereof covering the coordinates of the estimated position and set these cameras as nearby cameras Y.

This can be accomplished, for example, by storing in the nearby camera information storage 13 data of the radius of a circle which acts as the shooting area of the stationary camera 2 and whose center lies at the coordinates of the installation position of the camera 2, and causing the camera selection control 12A to determine whether or not the coordinates of the estimated position are within the shooting area of the stationary camera 2 centered at the coordinates of the installation position of the camera 2, the determination being made by comparing the distance from the coordinates of the estimated position to the coordinates of the installation position of the stationary camera 2 with the radial length of the circle.

The entire disclosure of Japanese patent application No. 2009-210220 filed on Sep. 11, 2009, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What I claim is:

1. An arrangement for controlling networked cameras held at respective positions and each having an imager whose shooting posture is controllable in response to control data, comprising:
a camera controller communicably connected to the networked cameras, and including a request data receiver operative in response to request data entered on a user terminal to produce the control data, said camera controller outputting the control data to the cameras; and
a video data detector for extracting motion picture data produced by shooting one of the cameras, the motion picture data being included in motion picture data produced by the cameras,
wherein said camera controller corrects, when receiving camera control request data for correcting the control data about the shooting camera from said request data receiver, the control data about the shooting camera and outputs the corrected control data to the shooting camera and a nearby camera located nearby the shooting camera.

2. The arrangement in accordance with claim 1, further comprising a nearby camera information storage for storing identification information about respective ones of the cameras and the identification information for identifying the nearby camera which is located adjacently to the cameras and which can shoot part of a boundary area of a shootable region of the cameras and a peripheral area neighboring the shootable region,
said nearby camera being identified by the identification information obtained from said nearby camera information storage based on the identification information about the shooting camera.

3. The arrangement in accordance with claim 2, wherein said nearby camera information storage further stores information about the positions at which the cameras are held in relation to the identification information about the cameras,
said camera controller obtaining, when receiving camera switching data for switching the shooting camera to different one of the cameras derived from said request data receiver, shooting direction information about the imager of the shooting camera from the control data about the shooting camera, and obtaining information about the position where the camera is held from said nearby camera information storage to set as a new shooting camera a nearby camera held at a position shifted in a shooting direction from the position at which the shooting camera is held.

4. The arrangement in accordance with claim 3, further comprising a control data storage for storing the control data about the respective cameras in relation to the identification information about the cameras,
said camera controller acquiring, when the camera control request data is received from said request data receiver, the control data about the shooting camera from said control data storage, and then corrects the control data with the camera control request data,
said camera controller storing, when outputting the control data about the shooting camera, the control data about the shooting camera in said control data storage with the control data associated with the identification information about the shooting camera and the identification information about the nearby camera located near the shooting camera.

5. The arrangement in accordance with claim 4, wherein said camera controller further comprises:
a camera selection controller which uses, when the camera control request data is received from said request data receiver, the identification information about the shooting camera to obtain the identification information about the nearby camera located near the shooting camera from said nearby camera information storage,
said camera selection controller obtaining, when the camera switching request data is received from said request data receiver, the control data about the shooting camera from said control data storage, and obtaining information on the shooting direction of the imager from the control data, said camera selection controller using the information stored in said nearby camera information storage about the positions at which the cameras are held to set the nearby camera located in the shooting direction of the shooting camera as a new shooting camera, said camera selection controller obtaining the identification information about the nearby camera located near the new shooting camera from said nearby camera information storage to produces shooting camera instruction data including the identification information about the new shooting camera; and
a control data supplier which obtains, when the camera control request data is received from said request data receiver, the identification information about the shooting camera and the identification information about the nearby camera from said camera selection controller, said control data supplier using the identification information about the shooting camera to obtain the control data about the shooting camera from said control data storage to correct the control data about the shooting camera with the camera control request data to store the corrected control data about the shooting camera in said control data storage in relation to the identification information about the shooting camera and also to the identification information about the nearby camera, said control data supplier outputting the corrected control data about the shooting camera to the shooting camera and to the nearby camera,
said control data supplier receiving, when the camera switching request data is received from said request data receiver, the identification information about the shooting camera and the identification information about the nearby camera from said camera selection controller, and using the identification information about the shooting camera to obtain the control data about the shooting camera from said control data storage to store the control data about the shooting camera in said control data storage in relation to the identification information about the shooting camera and also to the identification information about the nearby camera to output the corrected control data about the shooting camera to the shooting camera and the nearby camera.

6. The arrangement in accordance with claim 3, further comprising:
a virtual position storage for storing information on a virtual viewing location;
an input motion information storage for storing a set of data including the identification information about the shooting camera, input travel distance, and input shooting direction; and
a destination estimator for comparing newest one of the data stored in said input motion information storage with an immediately previously obtained one of the data, and calculating, if both are matched with each other, an estimated position of a destination shifted by the input travel distance from the virtual viewing location in the input shooting direction,
said camera controller referencing, when pseudo viewing location data indicating that the camera faces toward the virtual viewing location at the virtual viewing location is received from said request data receiver, said nearby camera information storage to set a camera closest to the virtual viewing location as the shooting camera to store the virtual viewing location in said virtual position storage,
said camera controller calculating, when the camera control request data including a zoom factor and input shooting direction is received from said request data receiver, the input travel distance from the zoom factor to store the input travel distance and the input shooting direction in said input motion information storage together with the identification information about the shooting camera thus obtained,
said camera controller receiving the estimated position of the destination from said destination estimator, and referencing said nearby camera information storage to set a camera closest to the estimated position of the destination as a nearby camera.

7. The arrangement in accordance with claim 6, wherein said nearby camera information storage stores information on the shootable regions of the respective cameras,
said camera controller determining, when the estimated position of the destination is received from said destination estimator, whether or not the estimated position of the destination lies within any one of the shootable regions of the cameras, said camera controller setting, if the estimated position lies within the shootable region, the camera having the shootable region as a nearby camera.

8. The arrangement in accordance with claim 1, wherein the shooting posture includes a shooting direction of the imager.

9. The arrangement in accordance with claim 1, wherein the shooting posture includes at least one of pan, tilt and zoom movements of the imager.
